(19) United States
(12) Patent Application Publication
(10) Pub. No.: US 2024/0132325 A1
(43) Pub. Date: Apr. 25, 2024

(54) METHOD, ELEVATOR, AND ELECTRIC POWER CONVERTER

(71) Applicant: KONE Corporation, Helsinki (FI)

(72) Inventors: Arto NAKARI, HELSINKI (FI); Olli POKKINEN, HELSINKI (FI); Teppo VUORIO, HELSINKI (FI)

(73) Assignee: KONE Corporation, Helsinki (FI)

(21) Appl. No.: 18/402,482

(22) Filed: Jan. 2, 2024

Related U.S. Application Data
(63) Continuation of application No. PCT/EP2021/069554, filed on Jul. 14, 2021.

(51) Int. Cl. B66B 1/32; B66B 1/34; B66B 1/36; B66B 5/02

(52) U.S. Cl. CPC B66B 1/32; B66B 1/3492; B66B 1/36; B66B 5/02

(57) ABSTRACT

A method includes monitoring position and/or movement of an elevator car in a standby mode of a braking arrangement, and activating the braking arrangement from the standby mode in response to a detection of a change in the position or of the movement. An elevator and an electric power converter are also disclosed.

### FIELD OF THE INVENTION

The present invention relates in general to elevators. In particular, however, not exclusively, the present invention concerns braking, such as dynamic braking, arrangements of motors of elevators, and methods of operation thereof.

### BACKGROUND

In known elevators, dynamic braking is done with normally closed (NC) electromechanical contactors which provide a short circuit between all motor phases, and, thus, no control power is required to activate the braking.

In some later solutions, as the electromechanical contactors introduced limited reliability, required large control power opening and keeping them open during elevator car movement, produced noise while operated and the cost was high, the use of electronic dynamic braking became favored solution by controlling power semiconductors switches to provide the short circuit between the motor phases.

One disadvantage of using the power semiconductors switches in comparison to the use of electromechanical contactors is the idle state losses. These losses occur because control circuitry of the power semiconductors switches must be kept active for supplying power to keep the switches in their conductive states to provide the braking. This leads to unnecessary losses in cases where the elevator car stands still due to the use elevator brakes, such as at a landing, in which case the dynamic braking would not be necessary for keeping the elevator car in its place.

### SUMMARY

An objective of the present invention is to provide a method, an elevator, and an electric power converter. Another objective of the present invention is that the method, the elevator, and the electric power converter provide braking of the elevator car more efficiently without compromising safety.

The objectives of the invention are reached by a method, an elevator, and an electric power converter as defined by the respective independent claims.

According to a first aspect, a method, such as for operating an elevator, is provided. The method comprises monitoring position and/or movement of an elevator car, such as in an elevator shaft or hoistway, in a standby mode of a braking arrangement and activating the braking arrangement from the standby mode in response to a detection of a change in the position or of the movement.

Term “movement” refers herein to movement with a constant speed, acceleration, deceleration, and/or jerk or the like movement due to which, for example, an elevator car moves/changes its position or is at least indirectly determined, such as based on operation of the elevator motor, to be moving/changing its position, preferably, along/within the elevator shaft.

Furthermore, in the standby mode, at least an electric power supply of the braking arrangement may be inactivated which the electric power supply may be configured to supply power for providing braking with respect to movement of the elevator car. In various embodiments of the method, the activating may thus comprise at least an activation of the electric power supply of the braking arrangement.

In various embodiments, the braking arrangement may, preferably, be in connection with an elevator motor which is arranged to cause moving of the elevator car.

Furthermore, the braking arrangement may be arranged to provide dynamic braking of the elevator motor. The dynamic braking may be provided by short-circuiting at least two motor phases relative to each other. The short-circuiting as referred to herein means a low ohmic connection between two motor phases, such as exhibiting less than one to few ohms, or even up to ten ohms. In some cases, there may be even up to 20 or 50-ohms resistor, or corresponding impedance, between the phases, depending on the embodiment and type of elevator motor, etc.

Alternatively or in addition, the dynamic braking may be provided by controllable power semiconductor device(s), such as by controlling the power semiconductor device(s) to be in the conductive state to cause the short-circuit.

In some preferable embodiments, the controllable power semiconductor devices may be comprised in an electric power converter, such as a frequency converter, which may be arranged to control the operation of the elevator motor.

In addition, the method may comprise initiating the standby mode prior to the activating. In some embodiments, the initiating may include a detection of an idle period related to operation of the elevator car. The idle period may be, for example, three minutes long. Alternatively or in addition, the initiating may include a detection of standstill of the elevator car, such as in a landing floor zone. In various embodiments, the standby mode may not be initiated before the elevator has stopped completely.

In various embodiments, the monitoring may be provided by a processing unit arranged to be active in the standby mode. Furthermore, the activating may comprise the processing unit providing an activation signal to the braking arrangement, such as to turn on the electrical power supply. The processing unit may be active even if it is physically part of the same device as other parts of the braking arrangement, for example, the other parts being the electrical power supply and, optionally, driver circuits of semiconductor devices, etc.

In various embodiments, the monitoring may comprise utilizing position, speed, and/or acceleration/deceleration measurement data from a sensor in connection with one of the following: the elevator motor, the elevator car, an elevator shaft. Furthermore, in an embodiment, the sensor in connection with the elevator motor may be a motor encoder.

In various embodiments, alternatively or in addition, the monitoring may include determining a voltage of an intermediate circuit of an electric power converter, or a phase-to-phase motor voltage, a phase-to-ground motor voltage, a motor phase-to-negative DC bus voltage, or a motor current.

Regarding the elevator motor, in some preferable embodiments, it may be a permanent magnet motor.

In various embodiments, the method may comprise, after and/or in response to the activating, providing dynamic braking of an elevator motor.

Alternatively or in addition, the method may comprise, moving the elevator car to a landing floor zone after stopping of the elevator car after the detection of the change in the position and/or of the movement.

Furthermore, the braking arrangement may be comprised in an electric power converter arranged to operate the elevator motor.

In some embodiments, the processing unit may be comprised in the electric power converter.

According to a second aspect, an elevator is provided. The elevator comprises an elevator car, an elevator motor arranged to cause moving of the elevator car, and a braking arrangement arranged to provide braking with respect to the elevator car. The elevator is configured to monitor position and/or movement of the elevator car in a standby mode of the braking arrangement, and to activate the braking arrangement from the standby mode in response to a detection of a change in the position and/or of the movement of the elevator car.

According to a third aspect, an electric power converter is provided. The electric power converter comprises a braking arrangement comprising an electrical power supply and configured to selectively be in a standby mode or in an active mode, and a processing unit arranged to be active in the standby mode, and to provide an activation signal to the braking arrangement in response to a detection of a change in the position and/or of the movement of the elevator car in the standby mode to activate the braking arrangement from the standby mode to the active mode. The standby mode may include at least having the electrical power supply inactivated, and the processing unit may, thus, be arranged to activate the electrical power supply from the standby mode.

The present invention provides a method, an elevator, and an electric power converter. The present invention provides advantages over known solutions in that it reduces standby mode power consumption and, therefore, increases the expected lifetime of the elevator drive control electronics, due to reducing thermal stress of components due to reduced duty without decreasing the level of safety in the system.

Various other advantages will become clear to a skilled person based on the following detailed description.

The expression “a plurality of” may refer to any positive integer starting from two (2), that is being at least two.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 shows a flow diagram of a method according to an embodiment.

FIG. 2 illustrates a braking arrangement according to an embodiment.

FIG. 3 illustrates schematically an elevator according to an embodiment.

FIG. 4 illustrates schematically an electric power converter according to an embodiment.

FIG. 5 illustrates schematically a processing unit according to an embodiment

### DETAILED DESCRIPTION OF SOME EMBODIMENTS

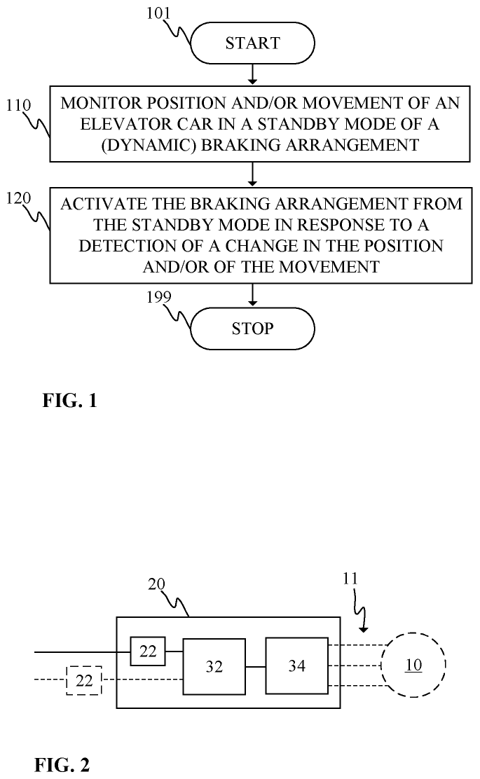

FIG. 1 shows a flow diagram of a method in accordance with an embodiment.

Optional item 101, or method step 101, refers to a start-up phase of the method. Suitable equipment and components are obtained and (sub-)systems assembled and configured for operation. This may entail either building and setting up a new elevator, or upgrading or renovating an old elevator.

Item 110, or method step 110, refers to monitoring position and/or movement of an elevator car in a standby mode of a braking arrangement.

In various embodiments, the monitoring 110 comprises utilizing position, speed, and/or acceleration/deceleration measurement data from a sensor in connection with one of the following: the elevator motor, the elevator car, an elevator shaft. The sensor in connection with the elevator motor may, preferably, be a motor encoder.

In various embodiments, alternatively or in addition, the monitoring 110 may include determining a voltage of an intermediate circuit of an electric power converter, or a phase-to-phase motor voltage, a phase-to-ground motor voltage, a motor phase-to-negative DC bus voltage, or a motor current. Furthermore, in some embodiments, the voltage of the intermediate circuit may be determined indirectly, such that the voltage is determined behind some device or (sub-)circuit arranged between the point of measurement and the intermediate circuit.

Item 120, or method step 120, refers to activating the braking arrangement from the standby mode in response to a detection of a change in the position and/or of the movement.

The activating 120 may be implemented in response to a sensor indicating the change in the position and/or of the movement, such as exceeding some suitably set low or moderate threshold. The threshold may be set related to movement of the elevator car directly, for movement of the elevator motor, such as based on the motor encoder, or for a voltage or current value related to the elevator motor and/or electric power converter operating the motor. For example, if a phase-to-phase voltage of the motor increases during the standby mode, it may be concluded that the motor, and thus the elevator car, is moving. Similar may be set for the intermediate voltage of an electric power converter operating the elevator motor.

Method execution may be stopped at item or method step 199. At this stage, the braking arrangement has been activated from the standby mode and is ready to provide braking. This may entail having the electrical power supply and, optionally, other equipment/devices, such as another processing unit, or a processor, and/or driver circuits of semiconductor devices, powered and set ready to operate for causing the braking, for instance. Thus, in the standby mode, at least the electrical power supply of the braking arrangement is inactivated, which the electrical power supply is preferably configured to supply power for providing braking with respect to movement of the elevator car.

As a non-limiting example regarding the method, the elevator car may be in a standstill and/or stopped at a landing floor zone or other position in the elevator shaft of the elevator. The elevator car is being held in its position, for example, by an elevator brake. During the standstill, such as after an idle period, the braking arrangement may be set to a standby mode in order to save energy. Then, during the standby mode, the elevator car may start to move for some reason, even if there hasn't been any elevator command or other signal which would indicate, for example the braking arrangement, that the elevator car is about to be moved. The reason may be, for example, the elevator brake being accidentally or carelessly opened by a service person or intentionally by a saboteur, or the elevator brake itself becomes faulty. The movement is thus, in the method, preferably detected due to monitoring thereof, and the braking arrangement may be quickly activated from the standby to become ready to provide braking or even start the braking immediately. Thus, during the standby mode, the braking arrangement did not consume electrical power via the operation of its components, however, the braking may be provided as soon as it is needed, thereby not compromising the safety of the elevator.

In view of the above, it becomes clear that during normal operating conditions of the elevator (such as the elevator car moving between landings based on elevator calls/commands), for example, the use of the elevator may be arranged to activate the braking arrangement from the standby mode before the elevator car is being moved.

In various embodiments, the activating 120 may thus comprises at least the activation of the electrical power supply of the braking arrangement. Furthermore, the other equipment/devices, such as the driver circuits of semiconductor devices, may optionally also be powered and set ready to operate for causing the braking, for instance.

In various preferable embodiments, the braking arrangement may be arranged to provide dynamic braking of the elevator motor. The dynamic braking may be provided by short-circuiting at least two motor phases relative to each other. Alternatively or in addition, the dynamic braking may be provided by controllable power semiconductor devices, such as of a separate braking arrangement in connection with the elevator motor 10, or of or in connection with an electric power converter arranged to operate the elevator motor 10. Thus, the controllable power semiconductor devices may be comprised in the electric power converter, such as a frequency converter. The controllable power semiconductor devices causing the short-circuit may be controlled to cause a continuous short-circuit or, alternatively, the devices may be controlled with pulses to cause on/off-pattern for the short-circuit condition, thereby controlling some aspects of the short-circuit condition, for example, the magnitude of the short-circuit current and/or the level of dynamic braking.

Furthermore, the method according to various embodiments may comprise initiating the standby mode prior to the activating 120. The initiating may include a detection of an idle period related to operation of the elevator car. For example, the braking arrangement may be deactivated, or set into the standby mode, after having received no operation signals for the past two or three minutes or so. There may also be a separate controller, such as an elevator controlling unit, initiating the standby mode. The skilled person understands that the idle period may be set to be as desired for the specific elevator. The idle period may, preferably, be at least about 10 or 30 seconds or longer.

Alternatively or in addition, the initiating may include a detection of standstill of the elevator car, such as in a landing floor zone (marked with reference sign 9 in FIG. 3). Thus, there may be a criterion set that the braking arrangement is not set into the standby mode, if the elevator car moves and/or if the elevator car is outside of the landing floor zone 9.

In some preferable embodiments, the method may comprise, after and/or in response to the activating 120, providing dynamic braking of the elevator motor. Thus, in addition to activating the braking arrangement and, optionally, other related equipment/devices, ready for operation, the braking arrangement may be set to actually provide the braking, such as the dynamic braking as described hereinabove.

In some embodiments, the method may comprise moving the elevator car to a landing floor zone, such as back to landing floor zone, after stopping of the elevator car after the detection of the change in the position and/or of the movement. This occurs preferably after the dynamic braking and detection of the elevator car to become stopped.

FIG. 2 illustrates a braking arrangement 20 according to an embodiment. The braking arrangement 20 may comprise at least an electrical power supply 32 and configured to selectively be in a standby mode or in an active mode. The electrical power supply 32 may, preferably, be arranged to provide power to control and/or operate the related equipment/devices 34 causing the braking, such as power semiconductor devices/switches causing the short circuit between motor phases 11 of the elevator motor 10. In various embodiments, the elevator motor 10 may be a permanent magnet motor.

As seen in FIG. 2, the braking arrangement 20 may also comprise a processing unit 22, such as comprising a processor and memory, for example, memory storage device or medium, arranged to be active in the standby mode, and to provide an activation signal to the braking arrangement 20 in response to a detection of a change in the position and/or of the movement of the elevator car in the standby mode to activate the braking arrangement from the standby mode to the active mode. However, as also shown in FIG. 2 with dashed lines, the processing unit 22 may, alternatively, be a separate device or unit relative to the braking arrangement 20, however, still arranged in connection thereto.

In various embodiments, the processing unit 22 may be powered and/or kept in its active state in order to at least execute the monitoring of the position/movement, alternatively or in addition, by a separate electrical power supply with respect to the electrical power supply 32.

Thus, in some embodiments, the monitoring 110 may be provided by the processing unit 22 which is arranged to be active in the standby mode of the braking arrangement 20. The activating 110 may then comprise the processing unit 22 providing an activation signal to or of the braking arrangement 20, such as to turn on the electrical power supply 32.

As also shown in FIG. 2, the braking arrangement 20 is, preferably, in connection with an elevator motor 10, such as via the motor phases 11, which is arranged to cause moving of the elevator car.

In some embodiments, as will be illustrated in and described in connection with FIG. 3, the braking arrangement 20 may be comprised in an electric power converter 24, such as in a frequency converter, arranged to operate the elevator motor 10. Alternatively or in addition, the processing unit 22 may be comprised in the electric power converter 24.

FIG. 3 illustrates schematically an elevator 100 according to an embodiment. The elevator 100 comprises the elevator car 5, the elevator motor 10 arranged to cause moving of the elevator car 5, and the braking arrangement 20 arranged to provide braking with respect to movement of the elevator car 5. The elevator 100 may be configured to monitor 110 a position and/or movement of the elevator car 5 in a standby mode of the braking arrangement 20, and activate 120 the braking arrangement 20 from the standby mode in response to a detection of a change in the position and/or of the movement of the elevator car 5.

As shown in FIG. 3, there may be a sensor 40A-40D in connection with one of the following: the elevator motor 10, the elevator car 5, an elevator shaft 12. The sensor 40A in connection with the elevator motor 10 may be a motor encoder. The sensor 40A-40D may be a position, speed, and/or acceleration/deceleration sensor for generating position, speed, and/or acceleration/deceleration measurement data. Such sensor 40A may, alternatively or in addition, be in connection with the traction sheave 16 or the like of the elevator 100. In FIG. 3, the sensor 40B may be arranged to the elevator car 5 for determining position, speed, and/or acceleration/deceleration of the elevator car 5. The sensor 40C, on the other hand, may be arranged to the elevator shaft 12. The sensor 40C may refer to absolute positioning means, in which case the sensor 40C may extend in the elevator shaft 12, continuously or in discrete steps, for providing absolute position information of the elevator car 5. Thus, as can be understood, the position, speed, and/or acceleration/deceleration measurement data may be generated by a combination of different sensors 40A-40C, such as having one sensor 40B, or part thereof, on the elevator car 5 and another one fixed to the elevator shaft 12 and arranged to co-act with the one in the elevator car 5. Still further, the sensor 40D may be a voltage or a current sensor for determining voltage or current of the motor 10 or the electric power converter 24.

Furthermore, the elevator car 5 may be mechanically coupled to the elevator motor 10, for example, by a hoisting rope 14. The operation of the elevator motor 10 may be controlled by an electric power converter 24, such as a frequency converter or an inverter. The hoisting rope 14 may comprise, for example, steel or carbon fibers. The term ‘hoisting rope’ does not limit the form of the element anyhow. For example, the hoisting rope 14 may be implemented as a rope or a belt.

The elevator 100 may comprise an elevator controlling unit 1000 for controlling the operation of the elevator 100. The elevator controlling unit 1000 may be a separate device or may be comprised in the other components of the elevator 100 such as in or as a part of the electric power converter 24. The elevator controlling unit 1000 may also be implemented in a distributed manner so that, e.g., one portion of the elevator controlling unit 1000 may be comprised in the electric power converter 24 and another portion in the elevator car 5. The elevator controlling unit 1000 may also be arranged in distributed manner at more than two locations or in more than two devices.

The elevator 1000 may comprise an elevator brake 17, preferably, an electromechanical elevator brake, for braking and/or holding the elevator car 5 to its position, such as at a landing 7. The brake(s) 17 may operate such that the magnetization of the coils of the brake(s) 17 deactivates the brake(s) 17 by force applied via magnetic field. The brake controlling unit (that is, the empty box above the brake shoe in FIG. 3) may be integrated into the brake 17 or may be a separate brake controller device. The brake 17 may be connected to the elevator controlling unit 1000.

Other elements shown in FIG. 3, which may or may not be part of some embodiments, are a main electrical power supply 90 such as a three- or single-phase electrical power grid, an electrical connection 95 thereto of the elevator 100. The elevator car 5 may operate in an elevator shaft or hoistway 14 serving landing floors 7. There may or may not be a counterweight 18 utilized in some embodiments.

According to an embodiment, the elevator motor 10 may be a single-phase, two-phase or three-phase electric motor. The elevator motor 10 may be a permanent magnet motor such as a surface-mounted or an interior permanent magnet motor. The elevator motor 10 may be a linear, radial, axial, or transverse type of a motor. A rotor of the permanent magnet motor has at least one permanent magnet providing magnetization of the rotor, i.e. excitation. In some embodiments, the elevator motor 10 may be a synchronous motor comprising a magnetizing circuit or an exciter in connection with the rotor. According to another embodiment, the elevator motor 10 may be an asynchronous electric motor such as an induction motor, or a doubly-fed induction motor or an asynchronous slip ring motor capable of being excited externally via the slip ring, for example, via brushes or wirelessly such as by induction. The excitation may be provided by, for example, a permanent magnet or a battery-operated exciter. The excitation may be based on injecting direct current (DC) into a magnetization circuit of the rotor, thus magnetizing the rotor. In various embodiments, the exciter may be at least partly coupled to the rotor.

According to an embodiment, the elevator 100 may comprise an auxiliary electrical power supply. The auxiliary electrical power supply may be utilized, for example, in situations in which there is a failure of a main electrical power supply 90 of the elevator 100, such as failure in an electrical power grid having, for example, a fundamental frequency of 50 or 60 Hz.

According to an embodiment, the elevator 1000 may comprise a back-up energy supply system or an auxiliary energy storage system such as an internal combustion engine, a fuel cell, a flywheel, or a lead, nickel-cadmium, nickel-metal hybrid, lithium ion, or lithium polymer battery delivering a voltage of 12 V, 24 V or 48 V, or at least a connection to such as a system or systems if not part of the elevator 100.

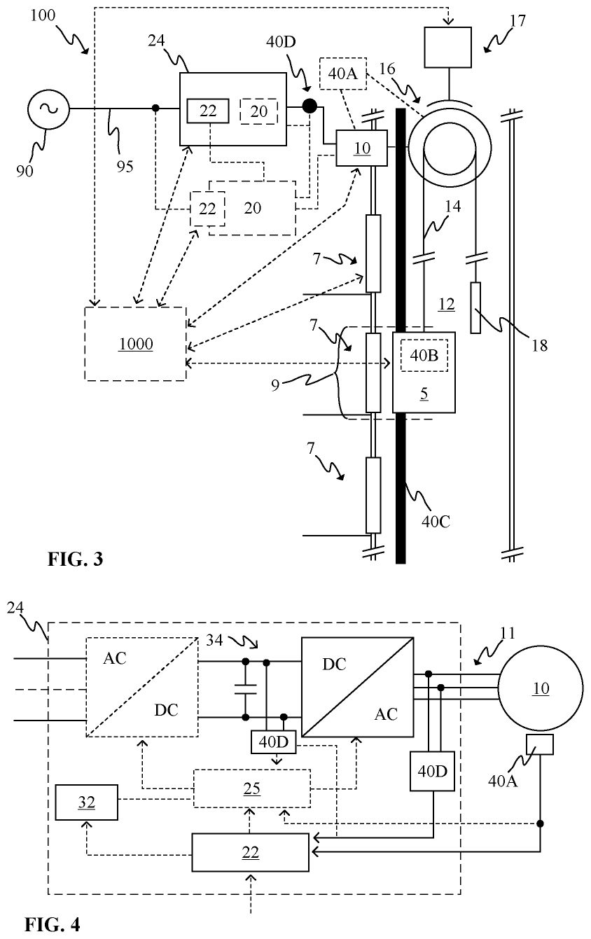

FIG. 4 illustrates schematically an electric power converter 24 according to an embodiment. In FIG. 4, the electric power converter 24 is a frequency converter, however, it could also be an inverter, if power is provided direct current (DC). As shown in FIG. 4, on the side of the motor 10 is the motor bridge of the converter 24. At least a portion of the controllable power semiconductor devices, such as low-side Insulated-Gate Bipolar Transistors (IGBTs) of the (full) bridge thereof, may be utilized to connect the motor phases 11 to each other to provide the dynamic braking. FIG. 4 also shows the processing unit 22 being part of the electric power converter 24, although it could also be separate device in connection thereto. FIG. 4 further illustrates an optional control block 25 which be configured to run the control algorithms to operate the motor 10. The control block 25 may be included in the other related equipment/devices 34 arranged to cause the dynamic braking as described hereinabove, although the control block 25 may also perform other tasks, such as control the operation of motor 10 during normal elevator operation. As understood by the skilled person, there may be voltage and/or current measurement inputted to control structure of the converter 24 from the input and/or output sides of the converter 24 in order to properly control the operation. Furthermore, in case of a frequency converter, the intermediate circuit having a capacitor is shown in FIG. 4.

The controllable power semiconductor devices of the DC-to-AC (alternating current) converter on the side of the motor 11 may thus include switches for operating the motor 11 during normal operating conditions, that is for moving the elevator car 5, but also equipment/devices 34 causing the braking, such as power semiconductor devices/switches causing the short circuit between motor phases 11 of the elevator motor 10 according to an embodiment.

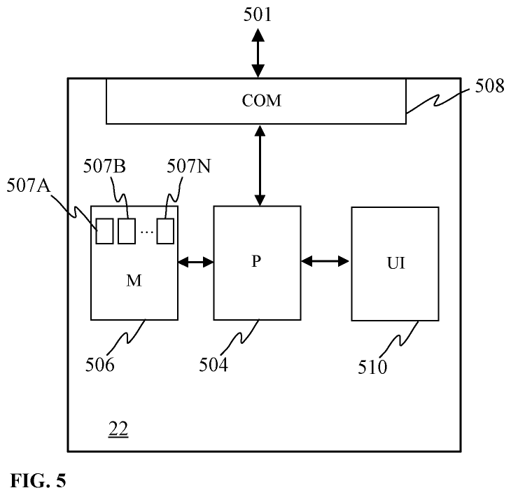

FIG. 5 illustrates schematically a processing unit 22 according to an embodiment. External units 501 may be connected to a communication interface 508 of the processing unit 22. External unit 501 may comprise wireless connection or a connection by a wired manner. The communication interface 508 provides interface for communication with external units 501 such as the elevator car 5, the elevator motor 10, the doors of the landing floors 7, or the electric power converter 24 to the processing unit 22. There may also be connecting to the external system, such as a laptop or a handheld device. There may also be a connection to a database of the elevator 100 or an external database including information used in controlling the operation of the elevator motor 10.

The processing unit 22 may comprise one or more processors 504, one or more memories 506 being volatile or non-volatile for storing portions of computer program code 507A-507N and any data values and possibly one or more user interface units 510. The mentioned elements may be communicatively coupled to each other with e.g. an internal bus.

The processor 504 of the processing unit 22 is at least configured to implement at least some method steps as described. The implementation of the method may be achieved by arranging the processor 504 to execute at least some portion of computer program code 507A-507N stored in the memory 506 causing the processor 504, and thus the processing unit 22, to implement one or more method steps as described. The processor 504 is thus arranged to access the memory 506 and retrieve and store any information therefrom and thereto. For sake of clarity, the processor 504 herein refers to any unit suitable for processing information and control the operation of the processing unit 22, among other tasks. The operations may also be implemented with a microcontroller solution with embedded software. Similarly, the memory 506 is not limited to a certain type of memory only, but any memory type suitable for storing the described pieces of information may be applied in the context of the present invention.

The specific examples provided in the description given above should not be construed as limiting the applicability and/or the interpretation of the appended claims. Lists and groups of examples provided in the description given above are not exhaustive unless otherwise explicitly stated.

1. A method comprising:
monitoring position and/or movement of an elevator car in a standby mode of a braking arrangement; and
activating the braking arrangement from the standby mode in response to a detection of a change in the position and/or of the movement.

2. The method of claim 1, wherein, in the standby mode, at least an electrical power supply of the braking arrangement is inactivated, the electrical power supply being configured to supply power for providing braking with respect to movement of the elevator car.

3. The method of claim 1, wherein the braking arrangement is in connection with an elevator motor which is arranged to cause moving of the elevator car.

4. The method of claim 1, wherein the activating comprises at least an activation of the electrical power supply of the braking arrangement, the electrical power supply configured to supply power for providing braking with respect to movement of the elevator car.

5. The method of claim 1, wherein the braking arrangement is arranged to provide dynamic braking of the elevator motor.

6. The method of claim 5, wherein the dynamic braking is provided by short-circuiting at least two motor phases relative to each other.

7. The method of claim 5, wherein the dynamic braking is provided by controllable power semiconductor devices.

8. The method of claim 7, wherein the controllable power semiconductor devices are comprised in an electric power converter, such as a frequency converter.

9. The method of claim 1, comprising initiating the standby mode prior to the activating.

10. The method of claim 9, wherein the initiating includes a detection of an idle period related to operation of the elevator car.

11. The method of claim 9, wherein the initiating includes a detection of standstill of the elevator car, such as in a landing floor zone.

12. The method of claim 1, wherein the monitoring is provided by a processing unit arranged to be active in the standby mode.

13. The method of claim 12, wherein the activating comprises the processing unit providing an activation signal to or of the braking arrangement, such as to turn on the electrical power supply.

14. The method of claim 1, wherein the monitoring comprises utilizing position, speed, and/or acceleration/deceleration measurement data from a sensor in connection with one of the following: the elevator motor, the elevator car, an elevator shaft.

15. The method of claim 14, wherein the sensor in connection with the elevator motor is a motor encoder.

16. The method of claim 1, wherein the monitoring includes determining a voltage of an intermediate circuit of an electric power converter, or a phase-to-phase motor voltage, a phase-to-ground motor voltage, a motor phase-to-negative DC bus voltage, or a motor current.

17. The method of claim 5, wherein the elevator motor is a permanent magnet motor.

18. The method of claim 1, comprising, after and/or in response to the activating, providing dynamic braking of an elevator motor.

19. The method of claim 1, comprising, moving the elevator car to a landing floor zone after stopping of the elevator car after the detection of the change in the position and/or of the movement.

20. The method claim 1, wherein the braking arrangement is comprised in an electric power converter, such as in a frequency converter, arranged to operate the elevator motor.

21. The method of claim 12, wherein the processing unit is comprised in the electric power converter.

22. An elevator comprising:
an elevator car;
an elevator motor arranged to cause moving of the elevator car;
a braking arrangement arranged to provide braking with respect to movement of the elevator car;
wherein the elevator is configured to:
monitor position and/or movement of the elevator car in a standby mode of the braking arrangement; and
activate the braking arrangement from the standby mode in response to a detection of a change in the position and/or of the movement of the elevator car.

23. An electric power converter comprising:
a braking arrangement comprising at least an electrical power supply and configured to selectively be in a standby mode or in an active mode;
a processing unit arranged to be active in the standby mode, and to provide an activation signal to the braking arrangement in response to a detection of a change in the position and/or the movement of the elevator car in the standby mode to activate the braking arrangement from the standby mode to the active mode.

24. The electric power converter of claim 23, wherein the standby mode includes at least having the electrical power supply inactivated, and the processing unit is arranged to activate the electrical power supply from the standby mode.
